(19) United States
(12) Patent Application Publication
(10) Pub. No.: US 2023/0303204 A1
(43) Pub. Date: Sep. 28, 2023

(54) PARKING BRAKE STRUCTURE

(71) Applicant: Honda Motor Co., Ltd., Tokyo (JP)

(72) Inventors: Koshi NAKAMURA, Tokyo (JP); Hideki KUWANO, Tokyo (JP)

(73) Assignee: Honda Motor Co., Ltd., Tokyo (JP)

(21) Appl. No.: 18/190,322

(22) Filed: Mar. 27, 2023

(30) Foreign Application Priority Data
Mar. 28, 2022 (JP) 2022-051180

(51) Int. Cl. B62L 1/00; B62J 45/412

(52) U.S. Cl. CPC B62L 1/005; B62J 45/412

(57) ABSTRACT

A parking brake structure having a simple configuration that is reduced in the number of parts and weight, is provided. The parking brake structure is for use in a vehicle that has a rear wheel brake including a rear wheel brake disc and a rear wheel brake caliper. The rear wheel brake disc has an outer circumferential end face that is provided with a plurality of recesses. The parking brake structure includes a locking member that is axially supported in a swingable manner to a bracket for supporting the rear wheel brake caliper. The locking member is formed with a protrusion engageable with the recess. The protrusion has a tapered shape that becomes thinner as it goes to a top, whereas the recess has a reverse tapered shape conforming to the shape of the protrusion. The bracket is attached with a vehicle speed sensor that measures vehicle speed based on a passing state of the recesses.

### BACKGROUND

### 1. Technical Field

The present invention relates to a parking brake structure and, in particular, to a parking brake structure used in a parking brake that prevents a wheel from rotating during stop of the vehicle.

### 2. Description of the Background

Parking brakes that prevent a wheel from rotating during stop of the vehicle are conventionally known.

Patent literature 1 discloses a disc-type wheel brake to be mounted to a rear wheel of a motorcycle. This rear wheel brake includes a brake caliper, which is used during usual driving, and a parking brake caliper, which prevents a rear wheel from rotating during stop of the motorcycle.

### CITATION LIST

### Patent Literature

Patent Literature 1: Japanese Patent No. 3848525

### BRIEF SUMMARY

Unfortunately, the parking brake caliper of Patent Literature 1 is configured to press pad members against a brake disc to generate friction, which complex structure tends to increase in the number of parts and weight.

An object of the present invention is to solve the problems in the existing technique described above and to provide a parking brake structure having a simple configuration that is reduced in the number of parts and weight.

In order to achieve the above object, a first aspect of the present invention provides a parking brake structure for use in a vehicle 1 that has a rear wheel brake BR including a rear wheel brake disc 21 and a rear wheel brake caliper 22. The rear wheel brake disc 21 has an outer circumferential end face that is provided with a plurality of recesses 50. The parking brake structure includes a locking member 60 that is axially supported in a swingable manner to a forward extended part 34 of a bracket 32 for supporting the rear wheel brake caliper 22. The locking member 60 is formed with a protrusion 62a engageable with the recess 50.

In a second aspect of the present invention, the protrusion 62a may have a tapered shape that becomes thinner as it goes to a top, whereas the recess 50 may have a reverse tapered shape conforming to the shape of the protrusion 62a.

In a third aspect of the present invention, the bracket 32 may be attached with a vehicle speed sensor 35 that measures vehicle speed based on a passing state of the recesses 50.

In a fourth aspect of the present invention, the vehicle 1 may include a swing arm 20 that rotatably and axially supports a rear wheel WR configured to be braked by the rear wheel brake BR. In this case, the locking member 60 may be configured to be disposed at a position overlapping the swing arm 20 in a vehicle side view.

In a fifth aspect of the present invention, the vehicle 1 may include a side stand 76, and the locking member 60 may be configured to engage with the recess 50 in response to a cable 38 being pulled in accordance with unfolding operation of the side stand 76.

In a sixth aspect of the present invention, the side stand 76 may be axially supported in a rotatable manner to a vehicle body by a rotation shaft 79a, and the side stand 76 may be provided with a pin 77 for pulling the cable 38. In this case, the parking brake structure may include a coupling member 90 for coupling the pin 77 and the cable 38, and the coupling member 90 may have a curved shape so as to avoid coming into contact with the rotation shaft 79a in a state in which the side stand 76 is unfolded.

In a seventh aspect of the present invention, the parking brake structure may further include a spring member 75 for applying a biasing force that makes the side stand 76 return in a predetermined direction. In this case, the spring member 75 may be configured to be disposed on an inner side in a vehicle-width direction of the side stand 76, and the coupling member 90 may be configured to be disposed between the side stand 76 and the spring member 75 in a vehicle rear view.

In an eighth aspect of the present invention, the bracket 32 and the forward extended part 34 may be separate bodies.

In the first aspect of the present invention, the parking brake structure is for use in the vehicle 1 that has the rear wheel brake BR including the rear wheel brake disc 21 and the rear wheel brake caliper 22. The rear wheel brake disc 21 has the outer circumferential end face that is provided with the plurality of recesses 50. The parking brake structure includes the locking member 60 that is axially supported in a swingable manner to the forward extended part 34 of the bracket 32 for supporting the rear wheel brake caliper 22. The locking member 60 is formed with the protrusion 62a engageable with the recess 50. The rear wheel is prevented from rotating, by engaging the protrusion of the locking member with the recess of the rear wheel brake disc; that is, a parking brake is provided by using this simple structure. Thus, compared with a structure having a parking brake caliper, it is possible to reduce the number of parts and weight of the structure.

In the second aspect of the present invention, the protrusion 62a has the tapered shape that becomes thinner as it goes to the top, whereas the recess 50 has the reverse tapered shape conforming to the shape of the protrusion 62a. These shapes enable smooth engagement and disengagement of the protrusion to the recess, resulting in improving operability of the parking brake.

In the third aspect of the present invention, the bracket 32 is attached with the vehicle speed sensor 35 that measures vehicle speed based on a passing state of the recesses 50. With this structure, the vehicle speed is measured by using the rear wheel brake disc, and it is possible to dispense with a pulser ring or the like for measuring vehicle speed. In addition, attaching the vehicle speed sensor to the bracket that supports the rear wheel brake caliper enables eliminating the need for a dedicated stay.

In the fourth aspect of the present invention, the vehicle 1 includes the swing arm 20 that rotatably and axially supports the rear wheel WR configured to be braked by the rear wheel brake BR. In this case, the locking member 60 is configured to be disposed at the position overlapping the swing arm 20 in a vehicle side view. Thus, the locking member is hidden by the swing arm, which structure improves an external appearance in a vehicle side view and protects the locking member from stones, etc., flying from a side of the vehicle body.

In the fifth aspect of the present invention, the vehicle 1 includes the side stand 76, and the locking member 60 is configured to engage with the recess 50 in response to the cable 38 being pulled in accordance with unfolding operation of the side stand 76. Under these conditions, the parking brake is actuated in response to operation to unfold the side stand, resulting in improving convenience.

In the sixth aspect of the present invention, the side stand 76 is axially supported in a rotatable manner to the vehicle body by the rotation shaft 79a, and the side stand 76 is provided with the pin 77 for pulling the cable 38. In this case, the parking brake structure includes the coupling member 90 for coupling the pin 77 and the cable 38, and the coupling member 90 has the curved shape so as to avoid coming into contact with the rotation shaft 79a in a state in which the side stand 76 is unfolded. This structure prevents the cable from wearing due to coming into contact with the rotation shaft.

In the seventh aspect of the present invention, the parking brake structure further includes the spring member 75 for applying the biasing force that makes the side stand 76 return in the predetermined direction. In this case, the spring member 75 is configured to be disposed on an inner side in the vehicle-width direction of the side stand 76, and the coupling member 90 is configured to be disposed between the side stand 76 and the spring member 75 in a vehicle rear view. Thus, compared with a case of disposing the coupling member on an inner side in the vehicle-width direction of the spring member or on an outer side in the vehicle-width direction of the side stand, this structure makes it possible to reduce dimensions of the coupling member and the whole system.

In the eighth aspect of the present invention, the bracket 32 and the forward extended part 34 are separate bodies, and therefore, it is possible to employ the parking brake structure in a wide variety of vehicles only by changing the shape of the forward extended part.

### BRIEF DESCRIPTION OF DRAWINGS

FIG. 1 is a right side view of a motorcycle using a parking brake structure according to one embodiment of the present invention.

FIG. 2 is an enlarged side view showing a structure around a rear wheel brake.

FIG. 3 is an enlarged side view showing the parking brake structure according to the embodiment.

FIG. 4 is a plane view showing the parking brake structure.

FIG. 5 is a side view showing a disengaged state between a recess and a locking member.

FIG. 6 is a side view showing an operating state of a lost motion mechanism.

FIG. 7 is an enlarged perspective view of a steering handlebar on a left side in a vehicle-width direction of the motorcycle.

FIG. 8 is a rear view of a side stand in an unfolded state, as seen from a rear side of a vehicle body.

FIG. 9 is an enlarged side view showing a folded state of the side stand.

FIG. 10 is an enlarged side view showing the unfolded state of the side stand.

### DETAILED DESCRIPTION

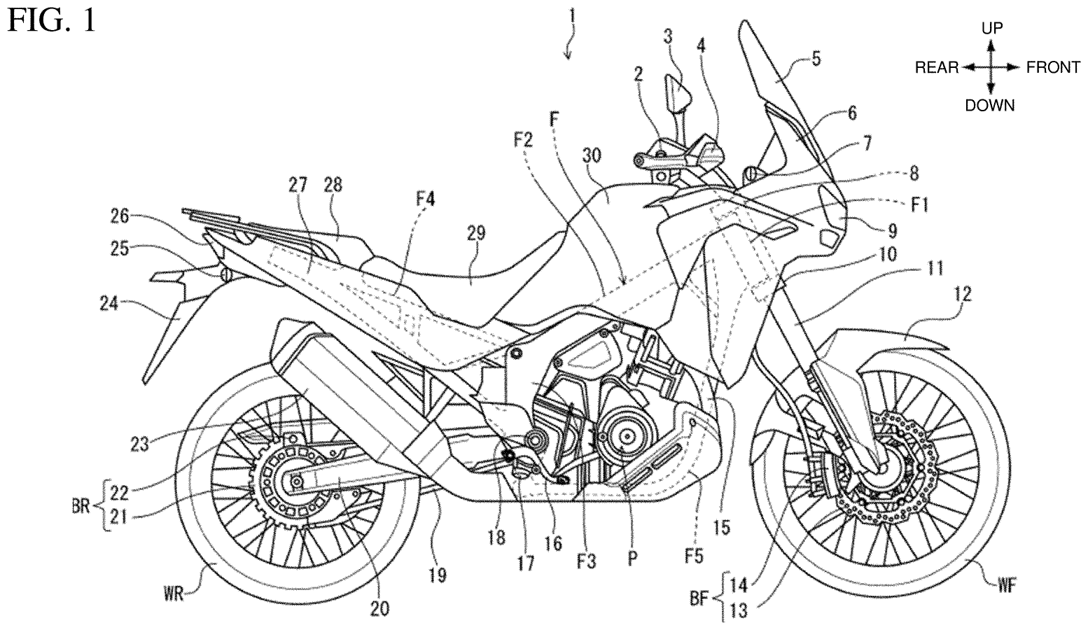

A preferred embodiment of the present invention will be described in detail with reference to the attached drawings, hereinafter. FIG. 1 is a right side view of a motorcycle 1 using a parking brake structure according to one embodiment of the present invention. The motorcycle 1 is a saddled vehicle that is driven by a driving force of a power unit P that is transmitted to a rear wheel WR via a drive chain 19. A head pipe F1 is positioned at a front end of a vehicle body frame F and axially supports a steering stem (not shown) in a swingable manner. A top bridge 8 and a bottom bridge 10, which support a front fork 11 consisting of paired right and left pipes, are fixed to an upper part and a lower part of the steering stem, respectively.

The top bridge 8 is mounted with a steering handlebar 2 at the top, and paired right and left knuckle guards 4 and paired right and left rear-view mirrors 3 are fixed to the steering handlebar 2. A front wheel brake disc 13 that rotates synchronously with a front wheel WF, and a front wheel brake caliper 14 that is fixed to the front fork 11, constitute a front wheel brake BF for applying a braking force to the front wheel WF. The front fork 11 is mounted with a front fender 12 that covers an upper part of the front wheel WF.

The head pipe F1 is mounted with a main frame F2 and an under frame F5 at a rear part. The main frame F2 consists of paired right and left pipes extending obliquely downward toward a rear side. The under frame F5 extends downward and supports a lower side of the power unit P. The main frame F2 is coupled to a pivot frame F3 at a rear end. The pivot frame F3 has a pivot 18 that axially supports a swing arm 20 in a swingable manner. A lower end part of the pivot frame F3 is coupled to a rear end part of the under frame F5. Paired right and left foot-rest steps 17 on which a driver can put the driver's feet, are mounted to the pivot frame F3.

The driving force of the power unit P, which is surrounded and supported by the main frame F2 and the under frame F5, is transmitted to the rear wheel WR via the drive chain 19. Combustion gas from the power unit P is discharged from a muffler 23 at a rear part of the vehicle body, via an exhaust pipe 15.

The rear wheel WR is axially supported in a rotatable manner at a rear end part of the swing arm 20, which is axially supported by the pivot 18. A rear wheel brake disc 21 that rotates synchronously with the rear wheel WR, and a rear wheel brake caliper 22 that is supported by the swing arm 20 and a rear wheel axle, constitute a rear wheel brake BR for applying a braking force to the rear wheel WR. A brake pedal 16 is disposed on a right side in the vehicle-width direction of the pivot frame F3. The brake pedal 16 is used to operate the rear wheel brake BR by the driver's right foot put on the foot-rest step 17.

A front cowl 6 is disposed in front of the head pipe F1, and the front cowl 6 supports a headlight 9, a windshield screen 5, and paired right and left front flasher lamps 7. A fuel tank 30 is disposed behind the front cowl 6 and on an upper part of the main frame F2. A rear frame F4 that supports a front seat 29 and a rear seat 28 is fixed at a rear part of the pivot frame F3. A rear cowl 27 covers right and left sides in the vehicle-width direction of the rear frame F4 and is mounted with a rear fender 24 at a rear end part. The rear fender 24 supports a tail light unit 26 and paired right and left rear flasher lamps 25.

The parking brake structure of this embodiment includes a swinging locking member configured to engage with a recess that is formed in an outer circumferential end face of the rear wheel brake disc 21. The locking member is engaged with the recess, whereby the rear wheel WR is prevented from rotating.

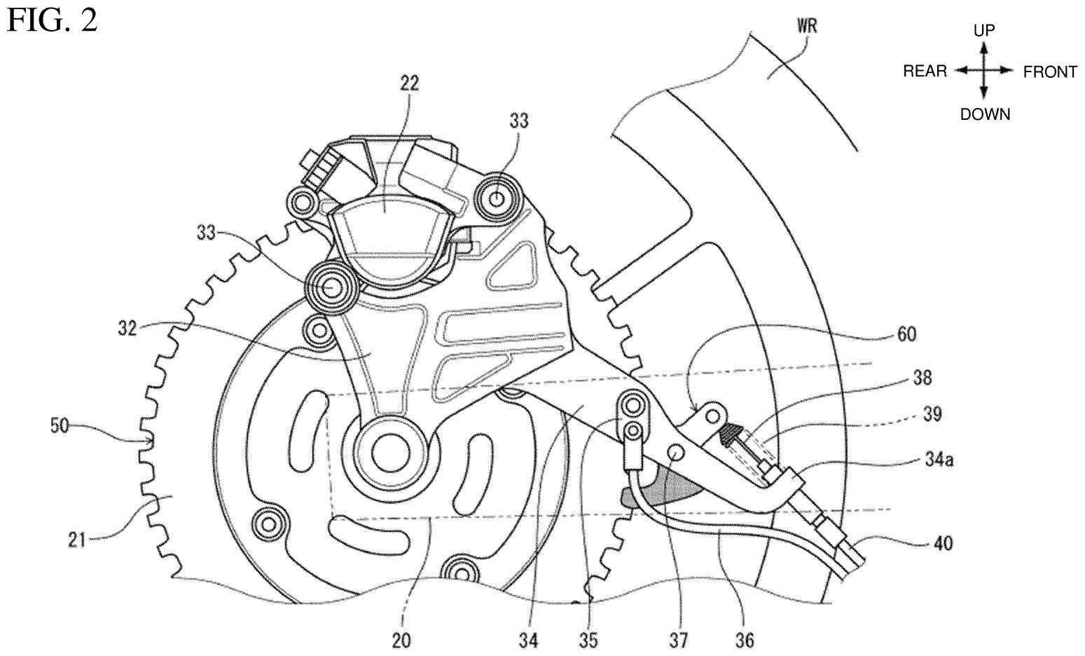

FIG. 2 is an enlarged side view showing a structure around the rear wheel brake BR. As described above, the rear wheel brake BR is composed of the rear wheel brake disc 21 and the rear wheel brake caliper 22. A plurality of recesses 50 are formed in the outer circumferential end face of the rear wheel brake disc 21. The rear wheel brake caliper 22 is fixed to a bracket 32 that is on an inner side in the vehicle-width direction of the swing arm 20, by two fixing members 33.

A forward extended part 34 for supporting the locking member 60 is attached to a front part of the bracket 32. The locking member 60 is axially supported in a swingable manner to the forward extended part 34 by a swing shaft 37. A cable support 34a that supports an outer cable 40 covering an inner cable 38 is provided at a front end part of the forward extended part 34. The inner cable 38 is coupled to an upper end part of the locking member 60 and swings the locking member 60 in a clockwise direction in the drawing, upon being pulled. A return spring 39 for applying a biasing force in a direction to return the locking member 60 to an initial position, is disposed between the locking member 60 and the cable support 34a. In this embodiment, the bracket 32 and the forward extended part 34 are separate bodies, and therefore, it is possible to employ the parking brake structure in a wide variety of vehicles only by changing the shape of the forward extended part 34.

The locking member 60 is disposed on a left side in the vehicle-width direction of the forward extended part 34. On the other hand, a vehicle speed sensor 35 that is coupled to a harness 36 is attached at a rear position of the swing shaft 37, on a right side in the vehicle-width direction of the forward extended part 34. In contrast to the locking member 60 being disposed on a left side in the vehicle-width direction of the forward extended part 34, the vehicle speed sensor 35 is disposed on a right side in the vehicle-width direction, whereby the harness 36 does not come into contact with the locking member 60.

The locking member 60 of this embodiment is disposed at a position overlapping the swing arm 20 in a vehicle side view. Thus, the locking member 60 is hidden by the swing arm 20, which structure improves an external appearance in a vehicle side view and protects the locking member 60 from stones, etc., flying from a side of the vehicle body.

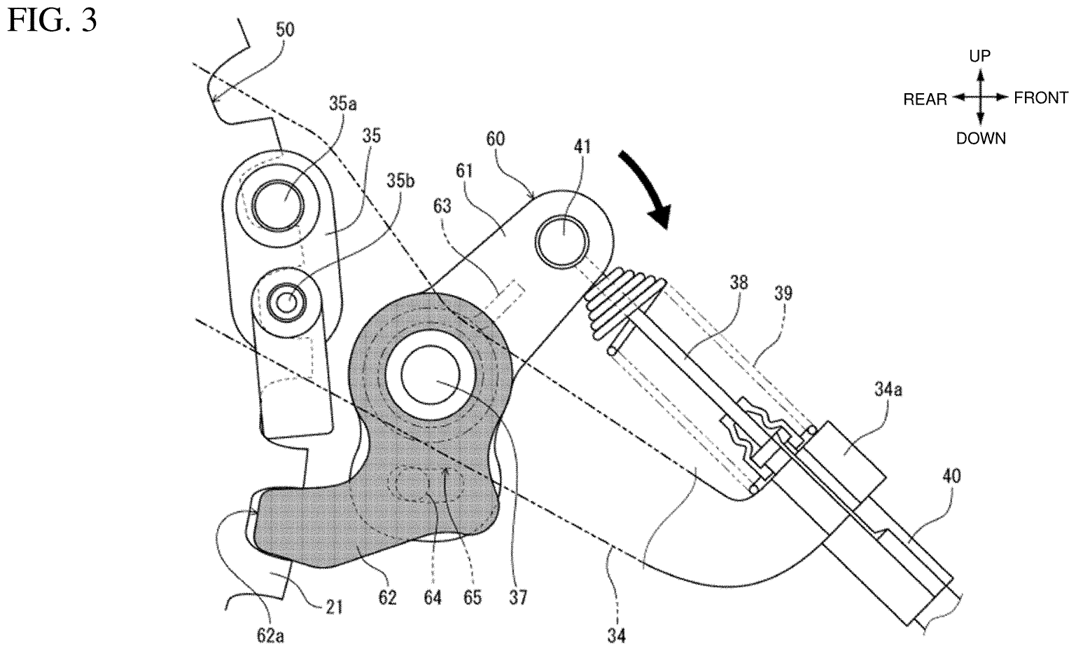

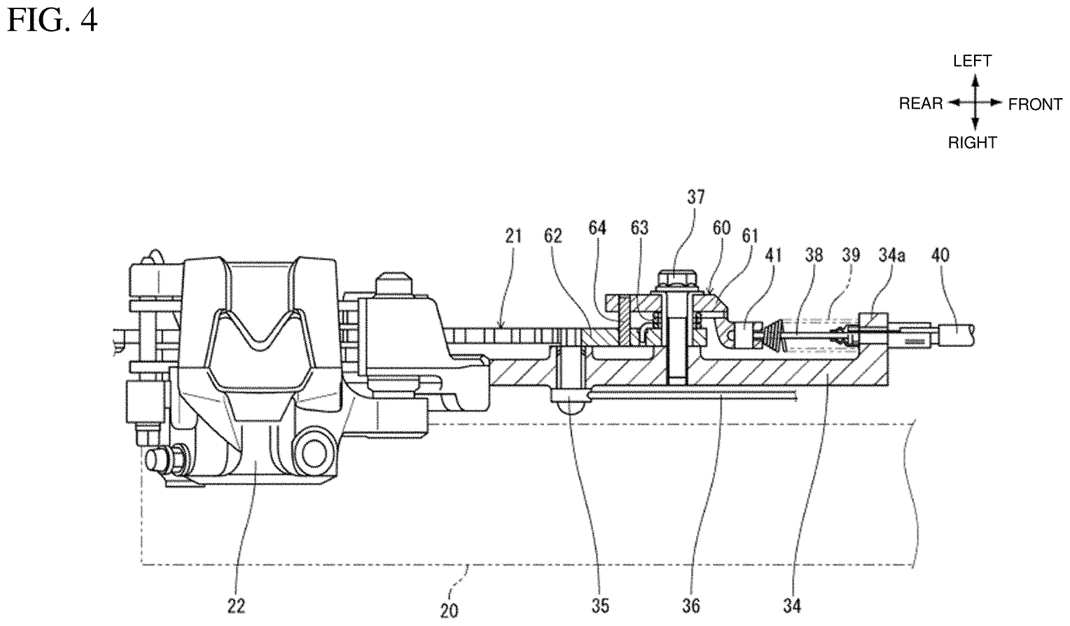

FIG. 3 is an enlarged side view showing the parking brake structure of this embodiment. In addition, FIG. 4 is a plane view showing the parking brake structure. The same reference signs as those described above represent the same or equivalent elements. The rear wheel brake disc 21 is a plate member with a thickness of approximately 5 mm. The locking member 60, which is configured to engage with the recess 50, is also a plate member with a thickness that is the same as or similar to that of the rear wheel brake disc 21.

The forward extended part 34 is attached with the vehicle speed sensor 35 that measures vehicle speed based on a passing state of the recesses 50. With this structure, the vehicle speed is measured by using the rear wheel brake disc 21, and it is possible to dispense with a pulser ring or the like for measuring vehicle speed. The vehicle speed sensor 35 is also disposed at a position hidden by the swing arm 20, in a vehicle side view, and it is thereby protected from stones, etc., flying from a side of the vehicle body. The vehicle speed sensor 35 includes a sensor unit 35b for measuring a passing state of the recesses 50 and also includes a fixing member 35a for fixing it to the forward extended part 34.

The locking member 60 includes a first member 61 that supports a cable end 41 of the inner cable 38 and also includes a second member 62 (gray-colored part in the drawings) having a protrusion 62a to be engaged with the recess 50. A lost motion mechanism is incorporated between these members. In more detail, the first member 61 and the second member 62 are axially supported in a mutually swingable manner, via a lost motion spring 63, and the swingable ranges thereof are limited by a limiting pin 64 provided to stand from the second member 62 and by a limiting hole 65 provided to the first member 61.

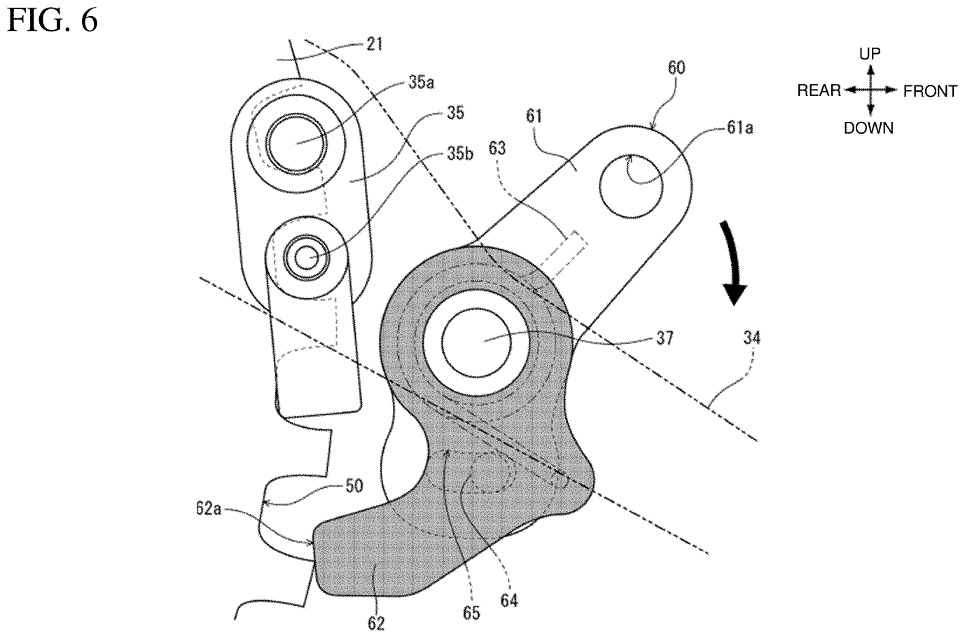

In response to the inner cable 38 being pulled, the locking member 60 swings in a clockwise direction in the drawing, and the protrusion 62a engages with the recess 50 of the rear wheel brake disc 21. This results in preventing the rear wheel WR from rotating; that is, a parking brake is provided by using this simple structure. Thus, compared with a structure having a parking brake caliper, it is possible to reduce the number of parts and weight of the structure. The lost motion mechanism operates when the protrusion 62a fails to engage with the recess 50 due to being in contact with a crest part formed between two recesses 50, although the inner cable 38 is pulled (refer to FIG. 6).

The protrusion 62a of the locking member 60 has a tapered shape that becomes thinner as it goes to the top, in a vehicle side view. On the other hand, the recess 50 has a reverse tapered shape that becomes wider in the opening dimension as it goes radially outward, in conformity with the shape of the protrusion 62a. These shapes enable smooth engagement and disengagement of the protrusion 62a to the recess 50, resulting in improving operability of the parking brake.

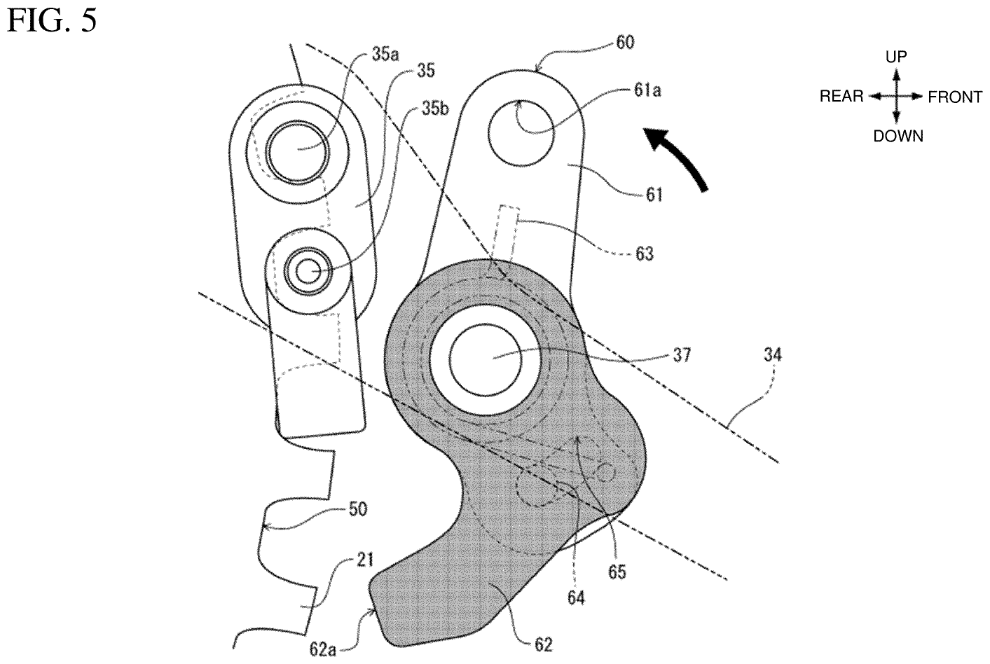

FIG. 5 is a side view showing a disengaged state between the recess 50 and the locking member 60. When the inner cable 38 is loosened, a force applied to an engaging hole 61a engaging with the cable end 41 is reduced. In response to this, the locking member 60 swings in a counterclockwise direction due to a biasing force of the return spring 39. Thus, the protrusion 62a and the recess 50 are disengaged from each other, and the parking brake is released.

FIG. 6 is a side view showing an operating state of the lost motion mechanism. As shown in the drawing, the lost motion mechanism operates when the protrusion 62a fails to engage with the recess 50 due to being in contact with a crest part formed between two recesses 50, although the inner cable 38 is pulled. In this state, the second member 62 is applied with the biasing force of the lost motion spring 63 and is able to engage with the recess 50 immediately after the rear wheel brake disc 21 rotates slightly.

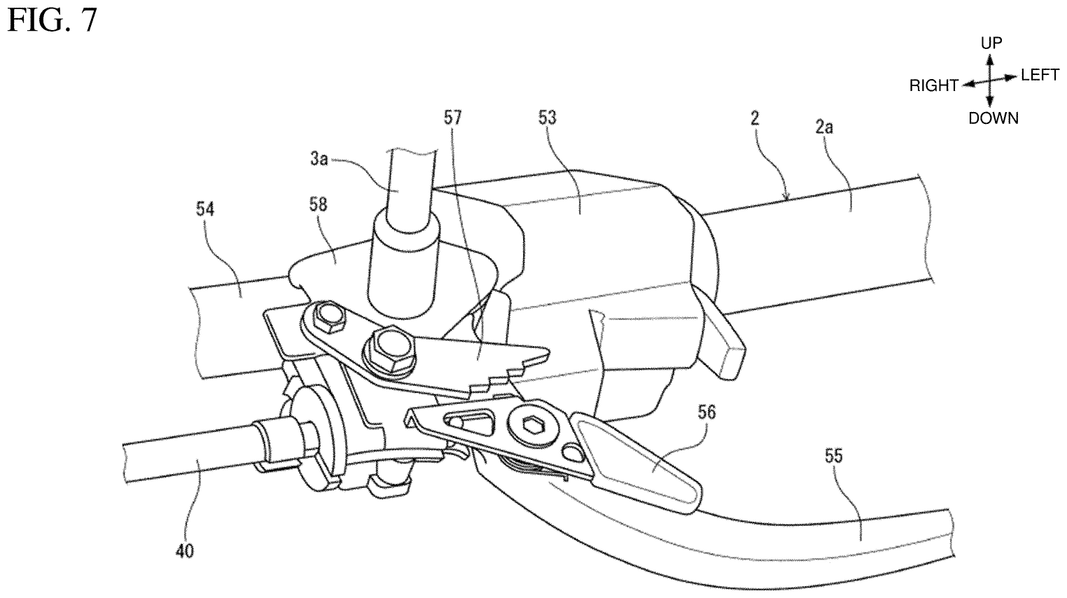

FIG. 7 is an enlarged perspective view of the steering handlebar 2 on a left side in the vehicle-width direction of the motorcycle 1. This drawing shows the steering handlebar 2 as seen from a front side of the vehicle body. In this embodiment, a lever 55, which is an operation element for the locking member 60, is attached to the steering handlebar 2 on the left side in the vehicle-width direction. A handle bar 54 is mounted with a lever support 58 that supports the lever 55, a handle switch 53, and a handle grip 2a. The lever support 58 is mounted with the outer cable 40 for operating the locking member 60, a stay 3a of the rear-view mirror 3, and a stopper base 57. Under these conditions, in response to a driver who holds the handle grip 2a grasping the lever 55, the locking member 60 engages with the recess 50 to lock the parking brake. In this state, a stopper lever 56, which is provided to the lever 55, is pushed to be engaged with the stopper base 57, whereby the position of the lever 55 is retained.

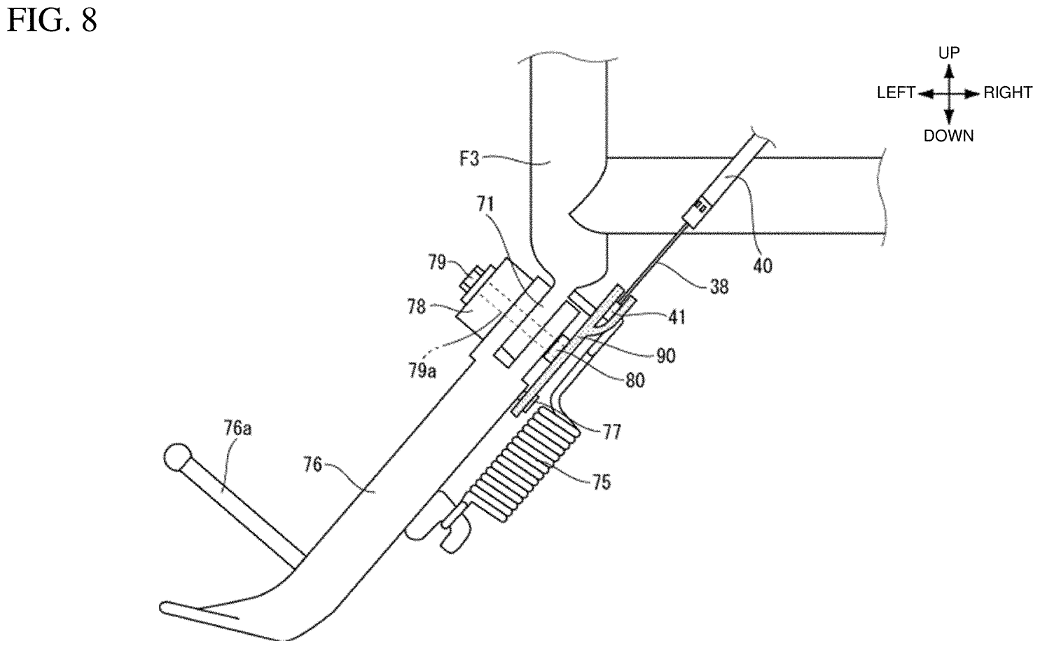

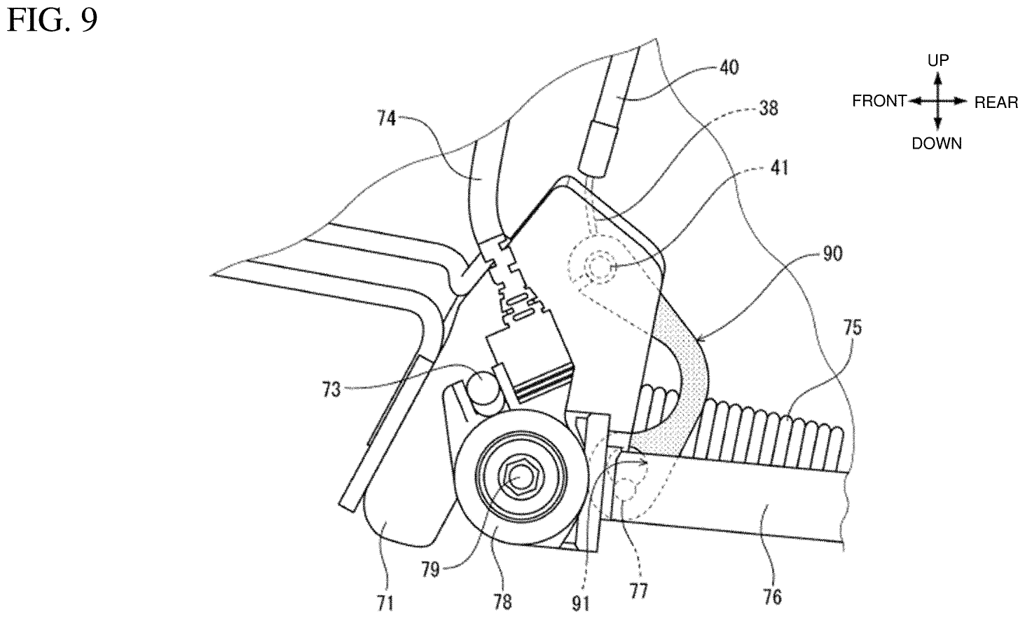

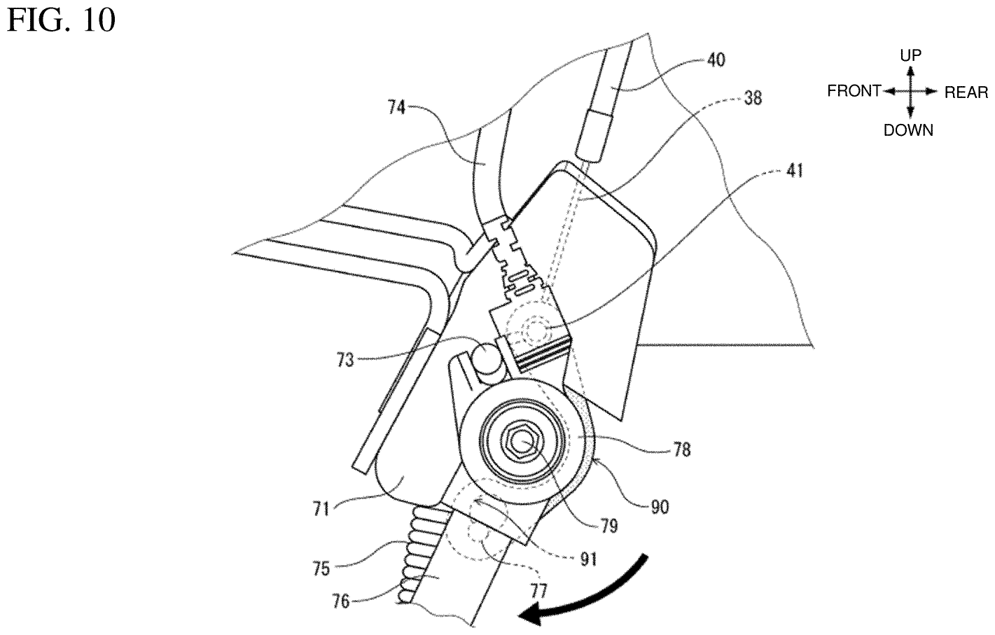

FIG. 8 is a rear view of the side stand 76 in an unfolded state, as seen from a rear side of the vehicle body. FIG. 9 is an enlarged side view showing a folded state of the side stand 76. FIG. 10 is an enlarged side view showing the unfolded state of the side stand 76. FIG. 7 shows a structure of the parking brake actuated by using the lever 55, whereas FIGS. 8 to 10 show a structure of the parking brake actuated in response to operation to unfold the side stand 76.

The side stand 76, which holds the vehicle body in an inclined state during stop of the vehicle, is provided on a left side in the vehicle-width direction of the motorcycle 1. In order to unfold the side stand 76, a control bar 76a is pushed down against a biasing force of a spring member 75 by the driver's foot. The side stand 76 is axially supported in a rotatable manner to a downwardly extended part 71 that is provided to the pivot frame F3 on a left side in the vehicle-width direction. The side stand 76 is tightened and fixed to the downwardly extended part 71 together with a side stand angle sensor 78 by a bolt 79 and a nut 80. The bolt 79 has a stem 79a that functions as a rotation shaft of the side stand 76. In addition, the side stand angle sensor 78 engages with a rotation preventing protrusion 73 and is connected to a wire 74 that outputs a sensor signal.

The outer cable 40 for operating the locking member 60 is routed to a back side of the side stand 76, and the cable end 41 of the inner cable 38 is coupled to an upper end part of a coupling member 90 (dot-hatched part in the drawings), which is formed of a plate member having a curved shape. On the other hand, a lower end part of the coupling member 90 engages with a pin 77 having a T-shaped cross section, which is provided to a back surface of the side stand 76. An engaging hole 91 is provided at the lower end part of the coupling member 90 and has a gourd shape in which a large diameter part and a small diameter part are combined. The large diameter part allows a large diameter part of the pin 77 to pass therethrough. The small diameter part allows a small diameter part of the pin 77 to pass therethrough.

With this structure, in response to the side stand 76 being unfolded, the inner cable 38 is pulled via the coupling member 90, resulting in actuating the parking brake. This further improves convenience of the motorcycle 1. In this embodiment, using the curved coupling member 90 enables the inner cable 38 to not come into contact with the rotation shaft 79a of the side stand 76 and the nut 80 screwed to the rotation shaft 79a and to be prevented from wearing.

In this embodiment, the pin 77 is provided to the back surface of the side stand 76, and the coupling member 90 is provided between the side stand 76 and the spring member 75 in a vehicle rear view. In this structure, the pin 77 and the coupling member 90 do not interfere with the spring member 75 even when the side stand 76 swings. Thus, for example, compared with a case of disposing the coupling member 90 on an inner side in the vehicle-width direction of the spring member 75 or on an outer side in the vehicle-width direction of the side stand 76, this structure makes it possible to reduce dimensions of the coupling member 90 and the whole system.

As described above, in the parking brake structure of the present invention, the plurality of recesses 50 are provided to the outer circumferential end face of the rear wheel brake disc 21, the locking member 60, which is formed with the protrusion 62a to be engaged with the recess 50, is axially supported in a swingable manner to the bracket 32 that supports the rear wheel brake caliper 22. The rear wheel WR is prevented from rotating, by engaging the protrusion 62a of the locking member 60 with the recess 50 of the rear wheel brake disc 21; that is, a parking brake is provided by using this simple structure. Thus, compared with a structure having a parking brake caliper, it is possible to reduce the number of parts and weight of the structure.

The above-described embodiment is not intended to limit the type of the motorcycle, the shape and structure of the rear wheel brake, the shape of the bracket that supports the rear wheel brake caliper, the shape and structure of the locking member, the shape and number of the recesses, the structure and disposed position of the vehicle speed sensor, etc., and various modifications and changes can be made thereto. For example, the parking brake may be actuated in response to operation to unfold a center stand that is configured to maintain the vehicle body in an upright state. The parking brake structure of the present invention is not limited to motorcycles, but it can be used in various vehicles, such as three-wheeled vehicles and four-wheeled vehicles.

### REFERENCE SIGNS LIST

1 . . . motorcycle (vehicle), 20 . . . swing arm, 21 . . . rear wheel brake disc, 22 . . . rear wheel brake caliper, 32 . . . bracket, 35 . . . vehicle speed sensor, 38 . . . inner cable, 50 . . . recess, 76 . . . side stand, 77 . . . pin, 79a . . . rotation shaft, 90 . . . coupling member, 60 . . . locking member, 62a . . . protrusion, BR . . . rear wheel brake, WR . . . rear wheel

What is claimed is:

1. A parking brake structure for use in a vehicle that has a rear wheel brake including a rear wheel brake disc and a rear wheel brake caliper,
the rear wheel brake disc having an outer circumferential end face that is provided with a plurality of recesses,
the parking brake structure comprising a locking member that is axially supported in a swingable manner to a forward extended part of a bracket for supporting the rear wheel brake caliper,
the locking member being formed with a protrusion engageable with the recess.

2. The parking brake structure according to claim 1, wherein the protrusion has a tapered shape that becomes thinner as it goes to a top, whereas the recess has a reverse tapered shape conforming to the shape of the protrusion.

3. The parking brake structure according to claim 1, wherein the bracket is attached with a vehicle speed sensor that measures vehicle speed based on a passing state of the recesses.

4. The parking brake structure according to claim 1, wherein the vehicle includes a swing arm that rotatably and axially supports a rear wheel configured to be braked by the rear wheel brake, and the locking member is configured to be disposed at a position overlapping the swing arm in a vehicle side view.

5. The parking brake structure according to claim 1, wherein the vehicle includes a side stand, and the locking member is configured to engage with the recess in response to a cable being pulled in accordance with unfolding operation of the side stand.

6. The parking brake structure according to claim 5, wherein the side stand is axially supported in a rotatable manner to a vehicle body by a rotation shaft,
the side stand is provided with a pin for pulling the cable,
the parking brake structure comprising a coupling member for coupling the pin and the cable, and
the coupling member has a curved shape so as to avoid coming into contact with the rotation shaft in a state in which the side stand is unfolded.

7. The parking brake structure according to claim 6, further comprising a spring member for applying a biasing force that makes the side stand return in a predetermined direction,
the spring member being configured to be disposed on an inner side in a vehicle-width direction of the side stand,
the coupling member being configured to be disposed between the side stand and the spring member in a vehicle rear view.

8. The parking brake structure according to claim 1, wherein the bracket and the forward extended part are separate bodies.

9. The parking brake structure according to claim 2, wherein the bracket is attached with a vehicle speed sensor that measures vehicle speed based on a passing state of the recesses.

10. The parking brake structure according to claim 2, wherein the vehicle includes a swing arm that rotatably and axially supports a rear wheel configured to be braked by the rear wheel brake, and the locking member is configured to be disposed at a position overlapping the swing arm in a vehicle side view.

11. The parking brake structure according to claim 3, wherein the vehicle includes a swing arm that rotatably and axially supports a rear wheel configured to be braked by the rear wheel brake, and the locking member is configured to be disposed at a position overlapping the swing arm in a vehicle side view.

12. The parking brake structure according to claim 2, wherein the vehicle includes a side stand, and the locking member is configured to engage with the recess in response to a cable being pulled in accordance with unfolding operation of the side stand.

13. The parking brake structure according to claim 3, wherein the vehicle includes a side stand, and the locking member is configured to engage with the recess in response to a cable being pulled in accordance with unfolding operation of the side stand.

14. The parking brake structure according to claim 4, wherein the vehicle includes a side stand, and the locking member is configured to engage with the recess in response to a cable being pulled in accordance with unfolding operation of the side stand.

15. The parking brake structure according to claim 2, wherein the bracket and the forward extended part are separate bodies.

16. The parking brake structure according to claim 3, wherein the bracket and the forward extended part are separate bodies.

17. The parking brake structure according to claim 4, wherein the bracket and the forward extended part are separate bodies.

18. The parking brake structure according to claim 5, wherein the bracket and the forward extended part are separate bodies.

19. The parking brake structure according to claim 6, wherein the bracket and the forward extended part are separate bodies.

20. The parking brake structure according to claim 7, wherein the bracket and the forward extended part are separate bodies.
